(19) United States
(12) Patent Application Publication
(10) Pub. No.: US 2016/0332903 A1
(43) Pub. Date: Nov. 17, 2016

(54) MOULD

(71) Applicant: BARBALAB S.R.L., Casalecchio di Reno (IT)

(72) Inventors: Giovanni Barbanti, Bologna (IT); Marco Faretra, Longiano (IT)

(21) Appl. No.: 15/111,592

(22) PCT Filed: Jan. 16, 2015
(86) PCT No.: PCT/IB2015/050342

§ 371 Date: Jul. 14, 2016

(30) Foreign Application Priority Data
Jan. 17, 2014 (IT) BO2014A000014

(51) Int. Cl. C03B 9/347

(52) U.S. Cl. CPC C03B 9/347

(57) ABSTRACT

Described is a mould, comprising a pair of mould parts (110, 111), stably couplable to each other during an operating cycle of the mould (100) and between them defining a space (120) for forming an object to be made, and at least one pair of inserts (1, 1′; 2, 2′) made of a material with a high degree of hardness, each of which is removably connected to a respective mould part (110, 111) and mutually engageable in a closed configuration of the mould (100).

### TECHNICAL FIELD

This invention relates to a mould, especially but not necessarily designed to be used for making containers, for example made of plastic or glass. An example of application of the mould according to this invention is the production of glass bottles obtained by blowing or mechanical pressing.

### BACKGROUND ART

Traditionally, the moulds comprise two (or more) mould parts or half-moulds, which can be coupled together in such a way that, in the abutting configuration, they delimit inside them a space in which the product to be obtained is made.

In order to guarantee the correct mutual positioning of the mould parts, there are suitable contact elements which guarantee, in the dosed configuration of the mould, a geometrically optimum and repeatable coupling between the mould parts.

The contact elements are defined by protrusions in the form of teeth shaped, for example, like a pyramid, projecting from the front surface of one mould part (that is to say, the surface facing the counter-mould) and insertable in corresponding recesses made in the counter-mould. The protrusions and the recesses are shaped to match each other to form a geometrically unique coupling between the two mould parts.

The projections are made in one piece with the mould part, normally made of cast iron or bronze, to guarantee that a correct and precise mutual positioning is obtained between the two mould parts during use, which is essential for the functionality of the mould. The coupling precision of the mould parts of the mould is, in fact, delegated merely to the projection-recess coupling.

Disadvantageously, this configuration has been found to be very vulnerable due to the difficult operating conditions of the mould, which cause a rapid deterioration of the geometrical and mechanical properties of the projections with a consequent loss of the correct geometrical coupling between the mould parts of the mould.

During use, in fact, there is a violent impact at every closing cycle between the two mould parts, which are moved by means of respective actuators (usually hydraulic) which must press together with force the two mould parts so as to guarantee a sufficient sealing action between them. This has negative repercussions on the above-mentioned projections which wear very quickly due to the impact forces to which they are continuously subjected. In terms of fatigue, it should also be noted that the moulds (particularly those for containers such as bottles or other commonly used containers) are used for a very high number of cycles, sometimes even several million.

Currently, this problem is overcome by taking apart the mould and repairing the individual projections by the addition of material and attempting to give the projection and the recess a shape which is as geometrically consistent as possible with the original shape and, if necessary, also intervening by hand or with plasma treatment. These procedures are very expensive and, due to the time necessary for their completion, lead to further very high costs due to the complexity of controlling the process, since the number of moulds necessary for making a predetermined type of container increases.

Other embodiments of moulds and respective contact elements are known from patent documents WO02058911, EP2111964, JP2012201576 and US2012161349. More specifically, WO02058911 and EP2111964 describe moulds having female-male contact elements fixed to the mould in a removable manner using screws. However, these solutions do not allow the contact elements to be locked to the mould in a simple, fast and precise fashion; moreover, these contact elements are awkward and difficult to remove. Moreover, the screws may easily come loose during operation of the moulds and cause damage. For this reason, these known solutions are not very reliable.

### AIM OF THE INVENTION

The aim of this invention is to provide a mould, preferably a mould for forming (in particular for blow-moulding) objects (in particular glass containers), which overcomes the above-mentioned drawbacks of the prior art.

More specifically, the aim of this invention is to provide a mould which offers a long service life and which, in particular, has a reduced wear of the above-mentioned projection-recess couplings and is easily repairable following their wear.

A further aim of the invention is to provide a mould having removable contact elements, wherein the fixing of these contact elements is particularly quick and precise.

A further aim of the invention is to provide a mould having removable contact elements, wherein the removal of the contact elements is particularly simple, quick and safe.

A further aim of the invention is to provide a mould having removable contact elements which is particularly robust, thereby reducing the risk of breaking the mould.

It should be noted that this invention applies to any mould having at least two mould parts movable relative to each other between an open and dosed position.

More specifically (but not necessarily), the mould is a mould for forming objects, for example for forming containers (in particular glass bottles). More specifically (but not necessarily), the mould is a mould for forming objects by blow-moulding, that is to say, a mould for blow-moulding, preferably a mould for blow-moulding containers (for example glass bottles).

The aim is fully achieved by the mould according to this invention, which comprises a pair of mould parts stably couplable to each other during an operating cycle of the mould and between them defining a space for forming an object to be made, and contact means acting between the two mould parts to determine mutual positioning of the two mould parts according to a predetermined arrangement in a dosed configuration of the mould.

The mould according to the invention is characterised according to the following claims.

More specifically, according to the invention, the contact means comprise at least one pair of inserts mutually engageable in the closed configuration of the mould, each of which is removably connected to a respective mould part.

The removable connection between insert and mould part exploits the elasticity of the materials, without using screws or other rigid connecting means like screws.

The removable coupling allows a complete replaceability of the damaged or worn inserts following repeated operating cycles without this causing consumption or damage to the mould parts.

Preferably, a first insert of the pair of inserts is of a “male” type and has a projection (for example, with a frustoconical transversal cross-section) whilst the second insert is of a “female” type and has a recess (for example, also having frustoconical transversal cross-section) designed to couple with the male projection; more specifically, in the closed configuration of the mould, the projection of the first insert engages in the female recess. Preferably, the male protrusion and the female recess comprise walls inclined relative to the plane for closing the moulds.

This configuration always allows an effective coupling between the inclined walls of the male insert with the inclined walls of the female insert. In light of this, it should be noted that the inclined walls are used to favour the entry of the coupling, starting from the assumption of a lack of precision of the movement of the two mould parts; in theory, the inserts, for the function to be performed, might also have a rectangular cross-section.

Thus, each insert (male or female) has an operating portion designed to come into contact with the respective operating portion of the corresponding insert (for example, a recess or a protrusion, female or male). However, it should also be noted that the inserts are all shaped in the same way, so that the male insert is equal to the female insert but mounted in a rotated or overturned position (for example, the operating portion could be made with an “N” shape, thereby defining both a projecting zone and a recess zone).

Advantageously, the inserts may be made of a material having a hardness greater than the material used to make the mould parts, for example tool steel.

According to another aspect of the invention, each insert comprises an anchoring portion which can be inserted in a hollow or groove made in the respective mould part.

Preferably, the Insert is connectable to the respective mould part by inserting the anchoring portion by sliding in a corresponding retaining groove of the respective mould part.

Preferably, each insert has an elongate shape along a longitudinal direction. Preferably, the corresponding grooves are also elongate along the longitudinal direction.

However, the inserts must also have different geometries; compact or with a substantially cylindrical or conical geometry.

Preferably, the mould parts of the pair of mould parts are hinged, so as to rotate mutually about an axis of rotation (alternatively, the two mould parts might be movable relative to each other by translation along a direction for example perpendicular to the closing plane). In light of this, preferably, the longitudinal direction is preferably parallel to the axis of rotation.

Each mould part has a closing face designed to be in contact with the closing face of the other mould part, in the dosed configuration of the mould; in the closed configuration of the mould, the closing faces of the mould parts lie in a closing plane the mould. The longitudinal direction along which the inserts are elongate is parallel to the closing faces of the mould parts.

Preferably, the mould has (at least) two pairs of inserts, coupled to two pairs of corresponding grooves. For this reason, preferably, each mould part has (at least) two grooves for coupling to (at least) two corresponding inserts. In light of this, preferably, the grooves defined by each mould part are aligned (and positioned one after the other, preferably spaced) along the longitudinal direction.

It should be noted that the two inserts of the pair of inserts (that is, the respective contact portions) define a closing surface, which intersects the closing plane of the mould parts in at least one closing line.

For this reason, the two inserts of the pair of Inserts define (at least) one closing line, preferably straight, between the two mould parts; preferably, the two inserts of the pair of inserts are slidably insertable in the respective retaining grooves along a direction parallel to the closing line.

Therefore, preferably, each insert has the main direction of longitudinal extension. This increases the resistance of the inserts, which provide a greater surface of action distributed along the closing line. The main direction of longitudinal extension may be, depending on the embodiment of the invention, perpendicular or parallel to a direction of insertion of the insert in the respective retaining groove.

If the direction of insertion of the insert in the respective retaining groove is the longitudinal direction, the retaining groove is open on the bottom wall of the mould part, so the insert is inserted in the retaining groove from the bottom face, and is made to slide longitudinally along the retaining groove.

In this situation, in one possible embodiment, the anchoring portion of each insert and the respective retaining groove are shaped in such a way as to form a grooved, or undercut, coupling designed to prevent extraction of the anchoring portion from the retaining groove along a direction perpendicular to the direction of reciprocal sliding.

This makes it possible to apply a sealing action by the mould part on the insert which can slide in the groove of the mould part along a direction transversal (and preferably perpendicular) to the direction on which the closing forces act (which are perpendicular to the closing line, identified from the pair of inserts).

Preferably, the grooved or undercut coupling is defined at least by a lateral tooth or protuberance made on a lateral wall of the insert and insertable, during sliding of the insert in the retaining groove, in a corresponding longitudinal seat made in the retaining groove. The lateral tooth (or protuberance) projects outside the outer dimension of the remaining part of the insert, in such a way as to define the above-mentioned undercut action. Moreover, the longitudinal seat is oriented laterally relative to the bottom of the groove and prevents an extraction of the insert which is not linked to a sliding of the insert in the retaining groove.

Alternatively, the inserts are free of transversely projecting parts, designed to be inserted in undercuts defined by the retaining grooves. This simplifies the operation of the mould and makes it possible to introduce the insert in the retaining groove along a direction of insertion perpendicular to the closing face of the mould part, that is to say, perpendicular to the longitudinal direction.

In this case, the retaining groove, preferably, is not completely open on the bottom wall of the mould part and has an opening, that is, an inlet mouth, for inserting or extracting the insert, made on the closing face of the mould part. The opening, or inlet mouth, of the retaining groove is delimited by a dosed perimeter; in other words, it is completely surrounded by the material constituting the mould part; in other words, it is positioned at a certain distance from the outer perimeter of the mould part. This increases the robustness of the mould part and it is particularly important if the mould part is made of a not very resistant material (for example, cast iron having a high graphite content).

Preferably, the grooves made in the mould parts of the mould each have walls (or faces) machined with particular precision (therefore made with a particularly accurate machining tolerance), because they define the contacts which determine the operating position of the respective inserts.

Preferably, at least a wall or face (of the groove) parallel with the closing plane of the mould parts is particularly precise; also, preferably, at least one of the walls perpendicular to the closing plane of the moulds (tangential) is particularly precise.

As regards the configuration of the anchoring portion of the insert, it should be noted that there are also different shapes alternative to that described above (having walls parallel and walls perpendicular to the closing plane of the moulds); for example, the insert has (in its portion for anchoring to the mould part) in a section perpendicular to the closing plane of the mould, a substantially circular profile, or in any case defined at least in part by a curved line (preferably, one or more circular arcs); a solution of this kind would have the advantage of simplifying the processing of the mould parts to make the hollows (or grooves), which would be at least partly defined by cylindrical holes.

Preferably, there are locking means acting between each insert and the respective mould part for stably retaining the insert in a locked position relative to the mould part, in particular a position of the insert fixed longitudinally along the retaining groove.

In an example embodiment, the anchoring portion is sized in such a way as to be engaged with clearance in the respective retaining groove.

In another example embodiment, each insert can be inserted and which can be housed with interference in the respective retaining groove. In that case, preferably, at least one portion of the mould is elastically deformable to allow the housing by interference. This simplifies the operation of the mould.

Preferably, the locking means comprise an elastic element expandable interposed between the anchoring portion and the respective retaining groove for pressing the anchoring portion against a contact surface of the retaining groove. Preferably, the elastic element is at least partly housed in a hollow (defining the undercut) of the insert. Preferably, the elastic element is at least partly positioned in a lateral recess (defining an undercut) defined by the retaining groove.

For this reason, operatively, the elastic element is contained in a space comprising partly the hollow of the insert and partly the lateral recess of the retaining groove. That allows the elastic element to press the Insert (that is, the anchoring portion of the insert) against the retaining groove developing a contact force having a first component perpendicular to the bottom wall of the groove (that is to say, perpendicular to the closing face of the mould) and a second, lateral, component perpendicular to the first component and perpendicular to the longitudinal direction (along which the insert is elongate).

Preferably, the elastic element is elongate along the longitudinal direction, in the operating position; preferably, the elastic element is a tubular pin and the space where the elastic element is contained is substantially cylindrical.

Preferably, the contact surface is made with a machining tolerance which is particularly stringent, that is, more stringent than the remaining part of the retaining groove, and is preferably at least partly flat or in any case characterised by a simple geometry (cylindrical) which makes precise couplings possible.

This makes it possible to guarantee a positioning of the insert inside the groove with a high precision, making possible a perfect geometrical cooperation between the two inserts of the pair of inserts.

In an embodiment, the locking means also comprise a plate which is deformable in a permanent fashion, and preferably in a reversible manner, having a first end connected to a respective mould part and a second end, opposite the first end, bendable against an outer surface of the anchoring portion for retaining the anchoring portion in a position in which it is inserted in the retaining groove. The second end thus defines a tab for retaining the insert in the respective groove.

This allows locking and unlocking the sliding of the insert into the respective groove easily and quickly, by folding the second end of the plate (for example, by using a hammer and/or a screwdriver).

In order to facilitate extraction of the inserts, each insert comprises at least one hole or cavity accessible from the outside for inserting a gripping end of an extractor tool. Preferably, the hole or cavity is shaped in such a way as to prevent material (for example, residue of glass or plastic) or dirt from accumulating inside it. For example, the hole or cavity is a dovetail hollow, made in each end of the insert and shaped in such a way as to receive and engage an extractor tool defining a hook-shaped portion.

In light of this, it should be noted that this invention also provides an extracting tool and a method for replacement of the inserts.

More specifically, the invention provides a method for carrying out maintenance on a mould for blow-moulding containers, for at least one mould part of a pair of mould parts of the mould.

The method comprises a step of extracting the Insert from the groove of the mould part; and a step of inserting in the groove a new insert replacing the one previously extracted.

An extractor tool is used for the extraction having an elongate member (rod-shaped) equipped with at least one (preferably two or more) protrusions.

The protrusions are inserted in the holes or recesses of the insert made at the ends of the insert; the extracting tool is then positioned parallel to the insert and a head portion of the extracting tool may be hit with a hammer to remove the insert, which is constrained to move along the groove of the mould part as one with the extracting tool, because the projections of the latter are coupled to the holes of the insert.

Preferably, each mould part has two inserts, aligned and juxtaposed along the direction of the groove of the mould part. In other words, it is preferable have the Insert (which substantially extends for the entire axial extension of the mould part) interrupted and divided into two separate trunks.

This facilitates the extraction, because it allows the insertion of two trunks, or half-inserts, separately, thus reducing the friction forces to be overcome.

As regards the step of inserting the insert in the groove, it comprises stably locking the insert in the respective groove, with the locking means described above: preferably, the plate and/or the elastic element.

In this regard, it should be noted that the plate preferably has a central portion interposed between the anchoring portion and the respective retaining groove, whilst the first end of the plate is inserted in a seat made in a surface of the mould part defining the respective retaining groove. For this reason, in the mounted configuration the insert holds the plate against the wall of the groove, preventing any accidental removal of the first end of the plate from the respective seat.

Moreover, the locking portion and the contact surface define between them a space for housing the central portion of the plate.

It should be noted that this invention also protects an insert, according to this invention, that is, a pair of inserts (having the role of male and female in the closing of the mould).

More specifically, the invention intends to protect an insert for blow-moulding containers; in particular, an insert removably couplable to a mould part of a pair of mould parts of the mould so as to constitute a contact element, acting between the mould parts to determine mutual positioning of the mould parts (according to a predetermined arrangement in a closed configuration of the mould).

The insert comprises an operating portion (that is, contact portion) which is prismatic (preferably with a frustoconical cross section, but it could also have another geometry, such as cylindrical, or even rectangular), of the male or female type, designed to be coupled to a corresponding operating portion of the other mould part of the pair of mould parts, and an anchoring portion for anchoring the insert of the mould part.

The anchoring portion is elongate along a direction of extension of the insert and facing in the opposite direction to the contact portion, relative to a direction transversal to the direction of extension.

This insert preferably has the features according to one or more of the appended claims to this document.

### BRIEF DESCRIPTION OF THE DRAWINGS

The technical features of the invention are dearly described in the claims below and its advantages are more apparent from the detailed description which follows, with reference to the accompanying drawings which illustrate a preferred, non-limiting example embodiment of the invention and in which:

FIG. 1 is an overall view of a mould in accordance with this invention and in an open configuration;

FIG. 2 is a front view of the mould of FIG. 1 in a dosed configuration;

FIG. 2A is an enlargement of the view of FIG. 2;

FIGS. 3-6 show four components of the mould of FIG. 1;

FIG. 7 is an exploded view of a portion of the mould of FIG. 1;

FIG. 8 shows a cross section of a part of the mould of FIG. 1 in an assembly sequence;

FIG. 9 shows the part of the mould of FIG. 8 after assembly has been completed;

FIG. 10 shows the mould of FIG. 1, according to another embodiment;

FIG. 11 shows one of the mould parts of the mould of FIG. 10, in an exploded perspective view;

FIG. 12 shows one of the inserts of the mould of FIG. 10, in a perspective view;

FIG. 13 shows a side view of the insert of FIG. 12;

FIG. 14 shows the detail A of FIG. 10.

FIG. 15 shows an exploded view of the mould of FIG. 1, in particular one of the mould parts of the mould, according to another embodiment;

FIG. 16 shows a plan view of the mould of FIG. 15;

FIG. 17 shows the detail B of FIG. 16;

FIG. 18 shows the mould of FIG. 15, in a cross section through the plane labelled I-I in FIG. 16;

FIG. 19 shows the mould of FIG. 15, in a cross section through the plane labelled II-II in FIG. 16;

FIG. 20 shows the mould of FIG. 15, in a cross section through the plane labelled III-III in FIG. 16;

FIG. 21 is a perspective view of the insert of the mould of FIG. 15;

FIG. 22 is a top view of the insert of the mould of FIG. 15;

FIG. 23 is a front view of the insert of the mould of FIG. 15.

### DETAILED DESCRIPTION OF PREFERRED EMBODIMENTS OF THE INVENTION

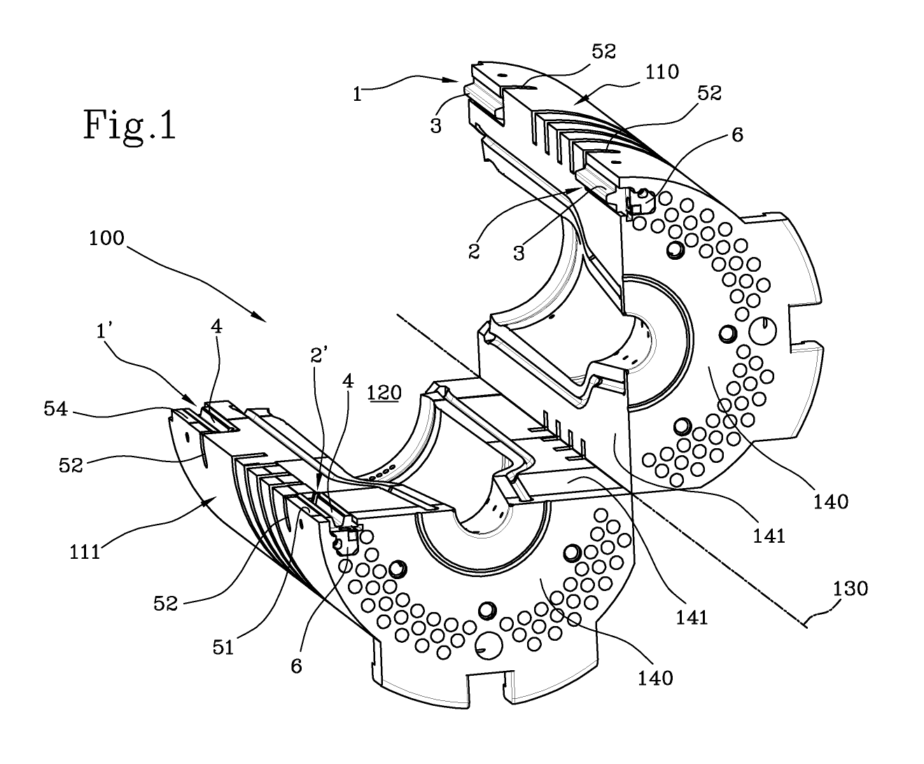

FIG. 1 shows a mould made according to this invention, in an open configuration.

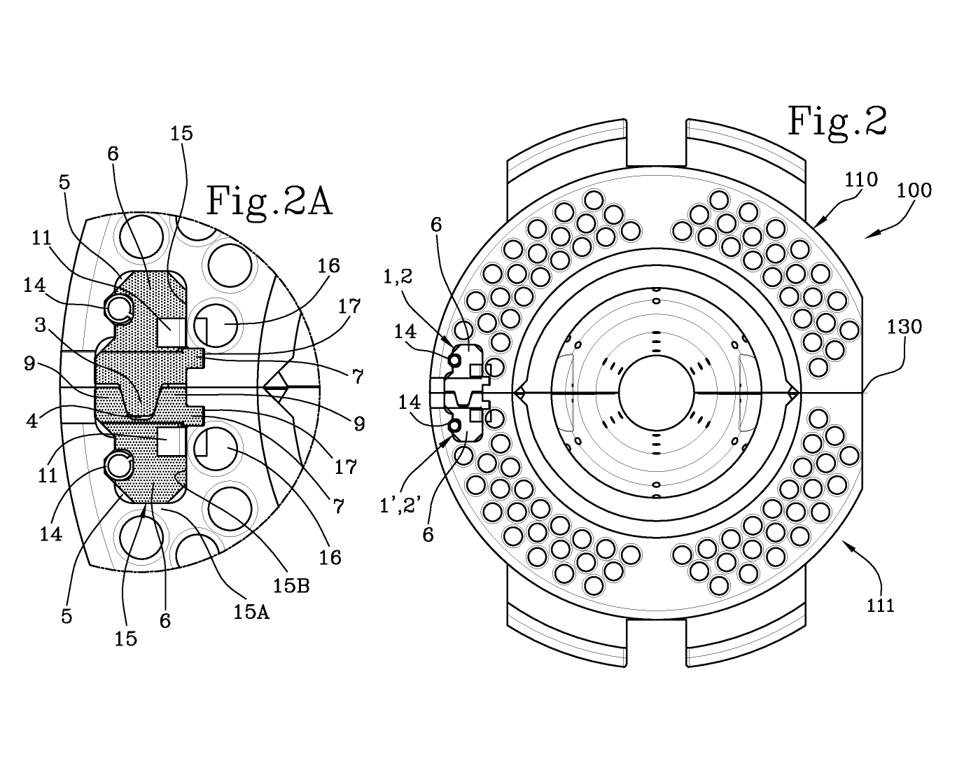

The mould, labelled 100 in its entirety, comprises two mould parts 110, 111, or half-moulds, which are movable between an open configuration, for loading and/or downloading (FIG. 1), and a dosed configuration (FIG. 2), for moulding or processing a product to be obtained.

The two mould parts 110, 111 define between them an internal space 120 which, in the specific embodiment illustrated, is used for making a glass bottle (for example a beer bottle) by blow-moulding a semi-finished item heated until reaching a suitable state for processing by plastic deformation by blow-moulding or mechanical compression.

The mould parts 110, 111, made of cast iron or bronze or materials commonly suitable for the purpose, are of known type and are not therefore described further.

The two mould parts 110, 111 are hinged together to rotate mutually about a hinge line 130 (the hinge line 130, in the embodiment illustrated by way of an example and without thereby limiting the scope of the invention, extends along corresponding end edges of the two mould parts 110).

Each mould part 110, 111 has a first and a second bottom wall 140, positioned at opposite ends relative to the longitudinal axis of the mould. Each bottom wall 140 is perpendicular to the longitudinal axis and is perpendicular to a closing plane of the mould.

Moreover, each mould part has a closing face 141 which, in the closed configuration of the mould, is positioned in contact with a corresponding closing face 141 of the other mould part, in a closing plane of the mould. Each closing face is flat and parallel to the longitudinal axis of the mould. Between the two mould parts are interposed contact means designed to determine a mutual positioning of the two mould parts 110, 111 according to a predetermined arrangement in the closed configuration of the mould 100.

The contact means are in the form of at least one pair (preferably two pairs) of inserts 1, 1′; 2, 2′ wherein the first insert 1, 2 of each pair is applied to a first mould part 110 whilst the corresponding second insert 1′, 2′ is applied to the second mould part 111.

Each pair of inserts 1, 1′; 2, 2′ defines a respective closing line (or segment), defined by a intersection between a closing plane of the mould parts and a closing surface defined by the inserts (that is, the surface wherein the inserts of the pair are in contact when the mould is closed).

Preferably, the inserts 1, 1′; 2, 2′ are positioned in such a way that the two closing lines (segments) are parallel and aligned with each other. Preferably, the two closing lines (segments) are parallel to the above-mentioned (longitudinal) hinge line 130.

The two inserts 1, 1′; 2, 2′ of each pair are mutually engageable in the closed configuration of the mould 100 to define the above-mentioned closing lines.

Each insert has an operating portion designed to come into contact, that is abut, the operating portion of the corresponding insert of the pair of inserts. The operating portions of the inserts of the pair are shaped in such a way as to match, when the mould parts and the inserts are in contact, that is to say, when the mould is closed.

In the example illustrated, each first insert 1, 2, that is, the operating portion of each insert, is of the “male” type, having a protrusion 3 defining a protuberance which extends away from the first mould part 110, in particular relative to a surface (or plane) of separation between the two mould parts 110, 111 to the second mould part 111 in the dosed configuration of the mould 100. The protrusion 3 has a main longitudinal direction of extension, which preferably extends parallel to the respective closing line.

It should be noted that the protrusion 3 (this applies to all the protrusions) has a transversal section (relative to the longitudinal direction of extension) which is uniform, that is to say, with a constant cross section. Alternatively, the protrusion 3 might have a variable section (a non constant nature of the section could allow the two mould parts to be positioned correctly also parallel to the line 130, which may be particularly useful if the mould is without a base).

In the example illustrated, the transversal cross section is frustoconical, having lateral faces convergent away from the respective first mould part 110.

In a substantially specular manner, each second insert 1′, 2′ is of a “female” type and has a recess 4 defining a hollow space which faces towards the second mould part 111 in the dosed configuration of the mould 100, and is designed to house the protrusion 3 of the corresponding first insert 1, 2 during the closing of the mould 100.

The recess 4 also has a main longitudinal direction of extension; preferably, it extends parallel to the respective closing line.

Similarly to what is stated above for the protrusions 3, the recesses 4 also have a predetermined transversal section (relative to the direction of extension) which is uniform, that is constant, or not uniform. In the example illustrated, the transversal cross section is frustoconical, having lateral faces convergent towards the depth of the recess 4.

In an example not illustrated, the operating portions of all the inserts also have the same shape (for example, comprising both a recess and a protrusion).

In an advantageous aspect of the invention, each insert 1, 1′; 2, 2′ is removably applied to the respective mould part 110, 111.

That is achieved by providing on the mould parts 110, 111, for each insert 1, 1′; 2, 2′, a respective retaining groove 5 in which an anchoring portion 6 of the respective insert 1, 1′; 2, 2′ can be slidably inserted.

The anchoring portion 6 is positioned on the opposite side relative to the operating portion, relative to an operating direction defined by the direction of moving of the inserts towards and away from each other.

Each retaining groove 5 has a direction of extension parallel to the closing line defined by the respective insert 1, 1′; 2, 2′. In other words, the retaining groove 5 is elongate along a longitudinal direction.

With regard to the Insertion and extraction of the inserts in and from the respective retaining grooves, there are various possibilities.

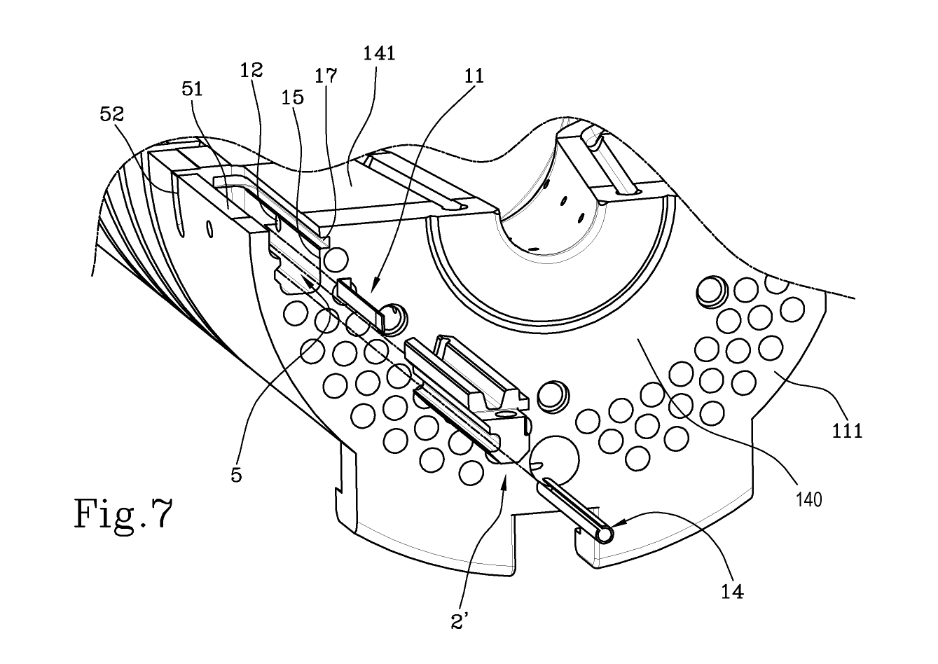

In a first embodiment, illustrated in FIGS. 1 to 9, the inserts 1, 1′; 2, 2′ are slidably insertable in the respective retaining grooves 5 along a direction parallel to the respective closing line. In order to favour the insertion of the anchoring portion 6 in the respective retaining groove 5, the anchoring portion 6 may have a tapered end profile (for example bevelled) facing towards the bottom of the retaining groove 5.

In this case, the retaining grooves 5 are open on the respective bottom faces 140 of the mould parts, for inserting the insert from the end of the groove open on the bottom face 140 and therefore accessible from the outside of the mould. The insert is moved to the operating position by longitudinally sliding along the retaining groove 5.

In this embodiment, the anchoring portion 6 of each insert 1, 1′; 2, 2′ and the respective retaining groove 5 are shaped in such a way as to form an undercut coupling designed to prevent extraction of the anchoring portion 6 from the retaining groove 5 along a direction perpendicular to the direction of reciprocal sliding between the anchoring portion 6 and the retaining groove 5. This prevents any possible accidental extraction of the insert 1, 1′; 2, 2′ which is not voluntarily made by withdrawing the insert 1, 1′; 2, 2′, along the retaining groove 5.

In the embodiment illustrated in FIGS. 2, 2A, 4 and 7, the anchoring portion 6 of each insert 1, 1′; 2, 2′ comprises a lateral tooth or protuberance 7 inserted in a corresponding seat 17 made in a wall of the mould part 110, 111 forming the respective retaining groove 5. Preferably, the tooth 7 extends for the entire extension of the anchoring portion 6 along the closing line.

In this embodiment, the direction of sliding of the insert along the retaining groove 5 is longitudinal (that is to say, parallel to the direction along which the insert is elongate). In this way, the anchoring portion 6 and the related retaining groove 5 form an undercut coupling, to prevent extraction of the anchoring portion 6 from the retaining groove 5 along a direction transversal to the direction of sliding. In this case, preferably, the anchoring portion 6 of each insert 1, 1′; 2, 2′ comprises a lateral protuberance 7 inserted in the corresponding seat 17 made in a wall of the mould part 110, 111 forming the respective retaining groove 5.

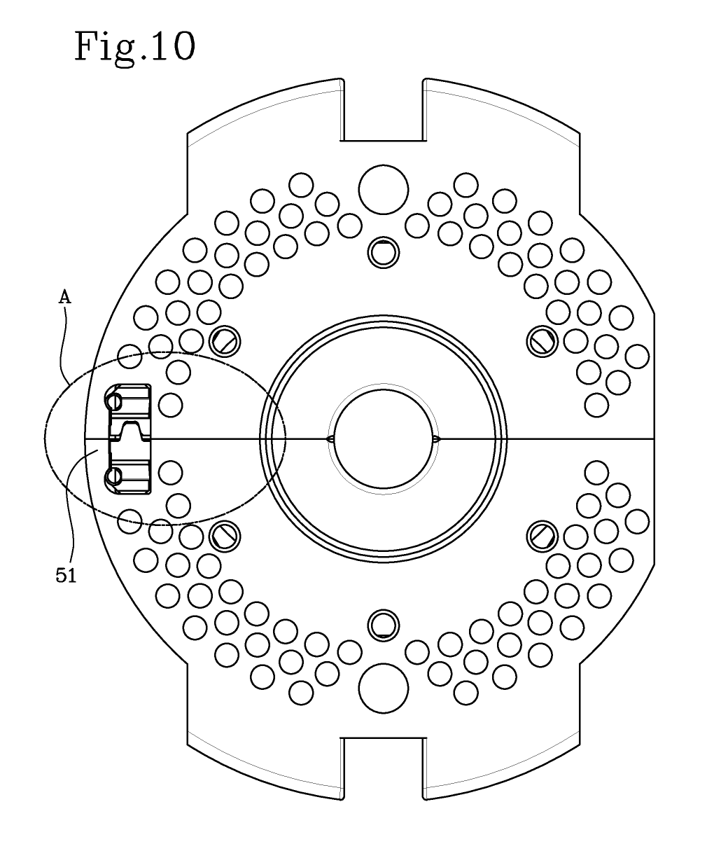

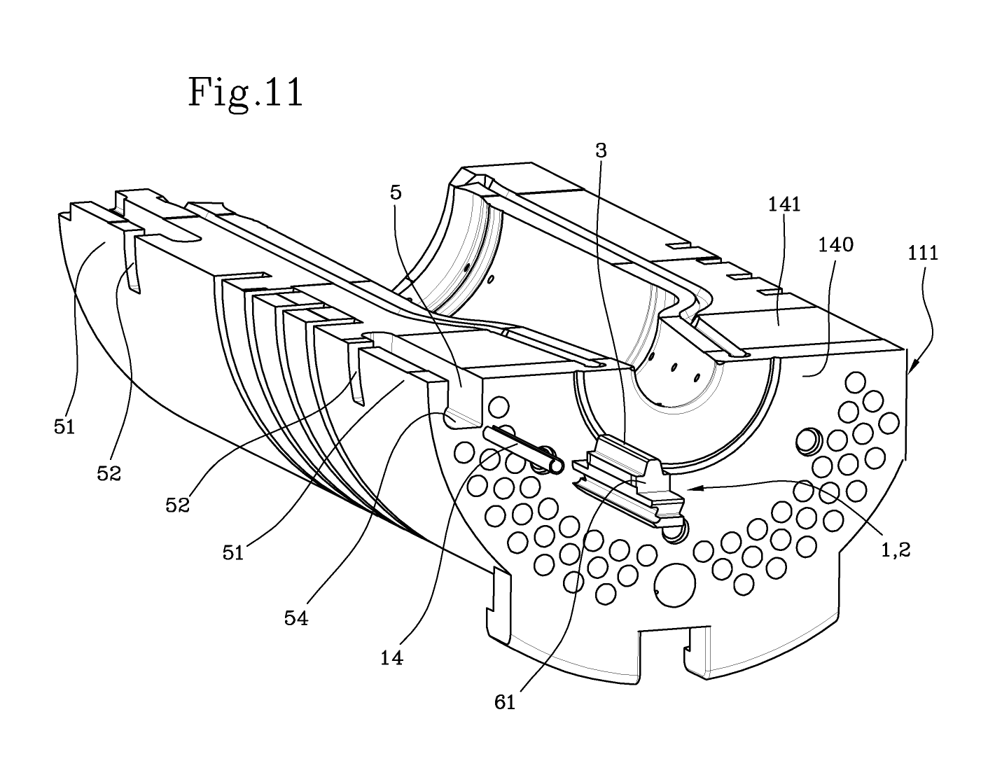

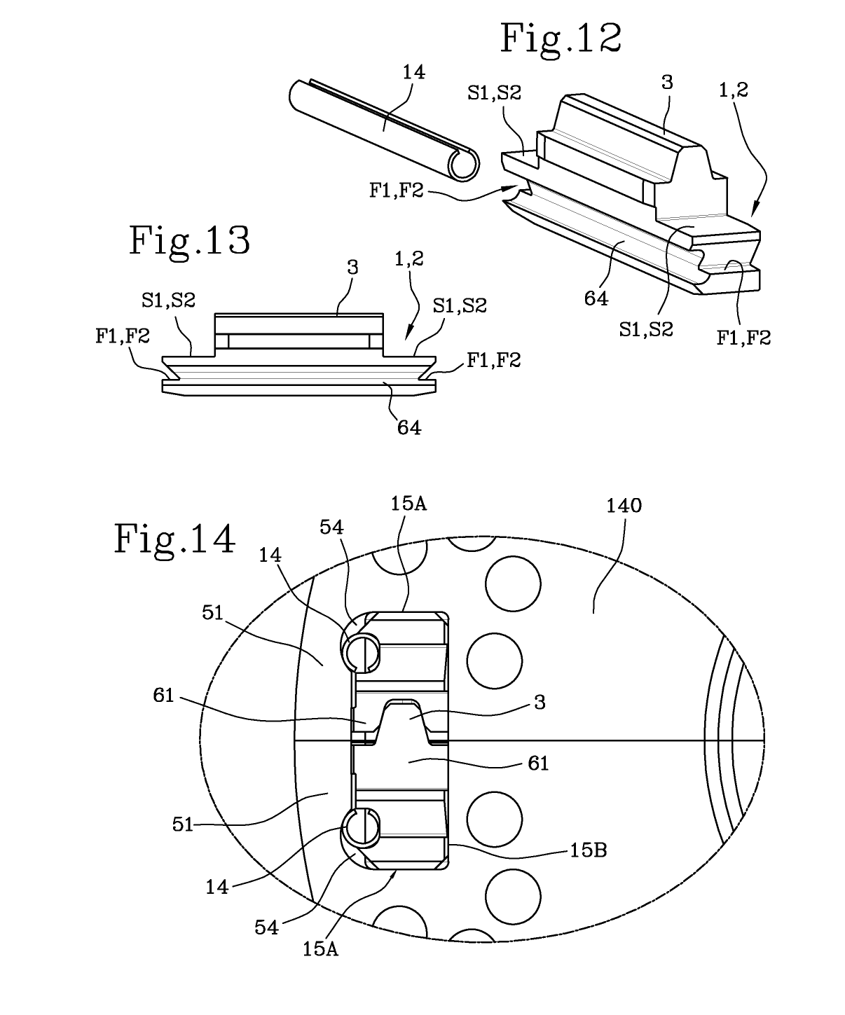

Another example embodiment is illustrated in FIGS. 10 to 14. In this second example, the retaining grooves 5 are open on the respective bottom faces 140 of the mould parts, as in the first example.

However, in the second embodiment the lateral protuberance 7 and the seat 17 are not present; this is in order to simplify the processing of the mould.

In this second example, the insertion of the recesses in the grooves might take place both by longitudinally sliding along the grooves 5 and by inserting along a direction perpendicular to the closing face 141 of the mould part, using the fact that, in the first and second embodiment, preferably, the retaining groove 5 is elastically deformable in a transversal direction (perpendicular to the longitudinal direction along which the groove 5 is elongate and perpendicular to the operating direction, that is, parallel to the closing face 141).

Preferably, each anchoring portion 6 and/or each retaining groove 5 are sized in such a way that each anchoring portion 6 is engaged with clearance in the respective retaining groove 5.

According to another aspect, in the first and second example embodiments mentioned above, each insert 1, 1′; 2, 2′ is also operatively housed in the respective retaining groove 5 by interference (in particular, elastic interference). In other words, some surfaces of the anchoring portion 6 of the insert are inserted with interference as well as with clearance, relative to corresponding contact surfaces of the retaining groove 5.

In the first and second embodiment, each mould part has a portion 51 delimiting a side of the retaining groove 5, wherein the portion 51 is elastically deformable to enlarge and narrow the retaining the groove 5 in a direction transversal to a direction of moving towards each other of the inserts.

Preferably, the elastically deformable portion 51 is interposed between the retaining groove 5 and an outer periphery of the mould; preferably, the elastically deformable portion 51 constitutes a wing (that is to say, it is wing-shaped) and surrounds a side (the outer side) of the retaining groove 5.

Along the longitudinal direction, the wing (elastically deformable portion 51) is delimited by one of the ends of the mould part (on one side) and by a recess 52 which places the retaining groove 5 in communication with the outside of the mould.

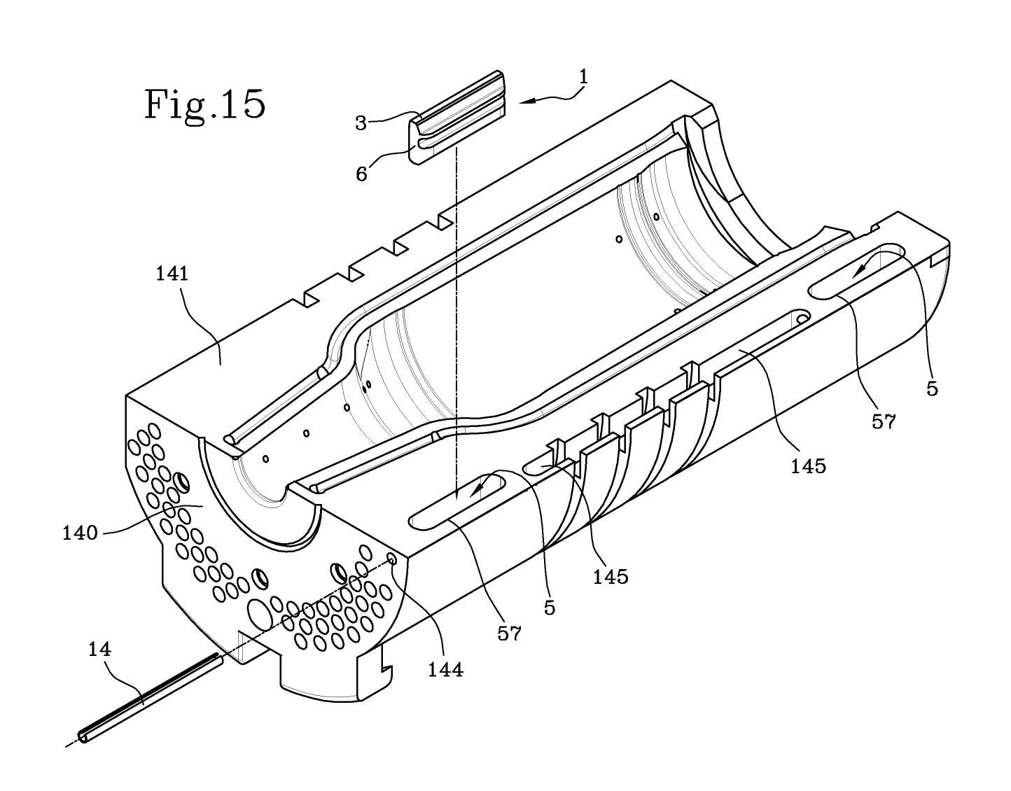

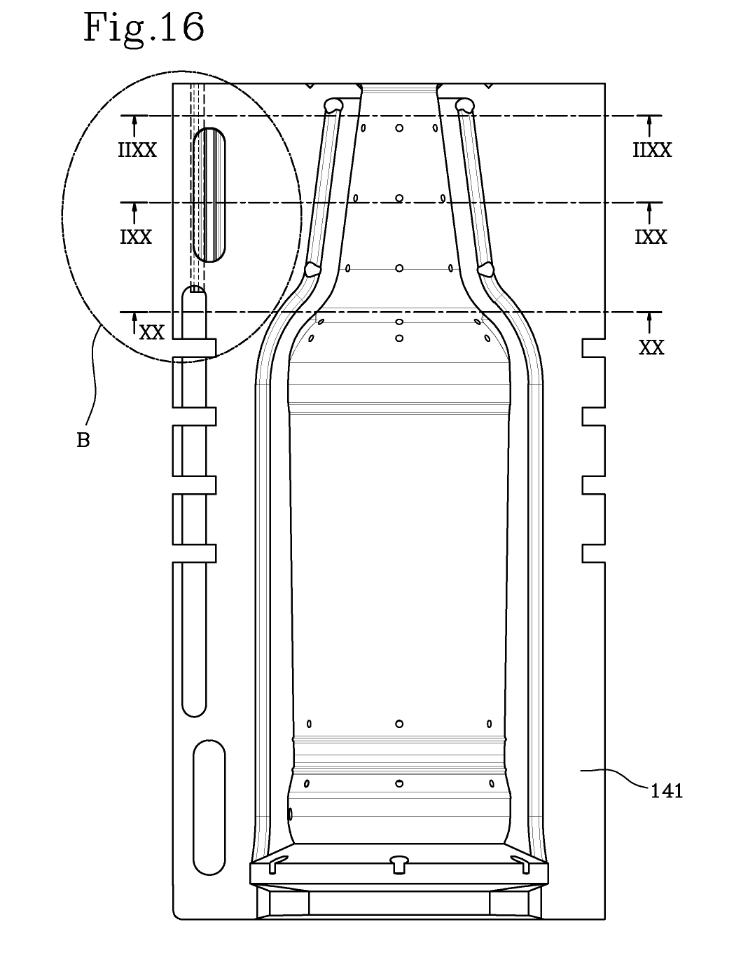

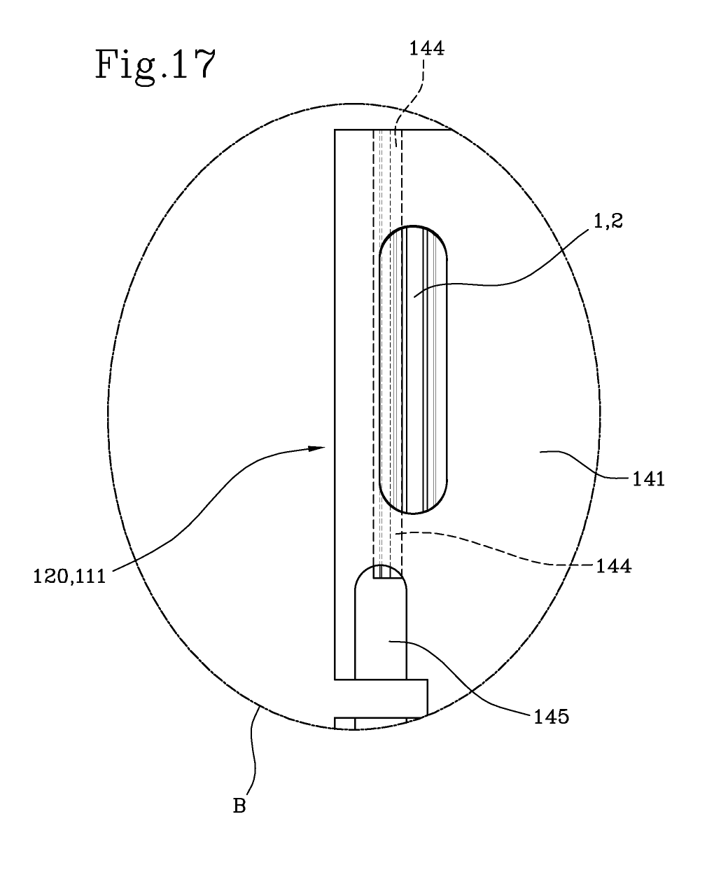

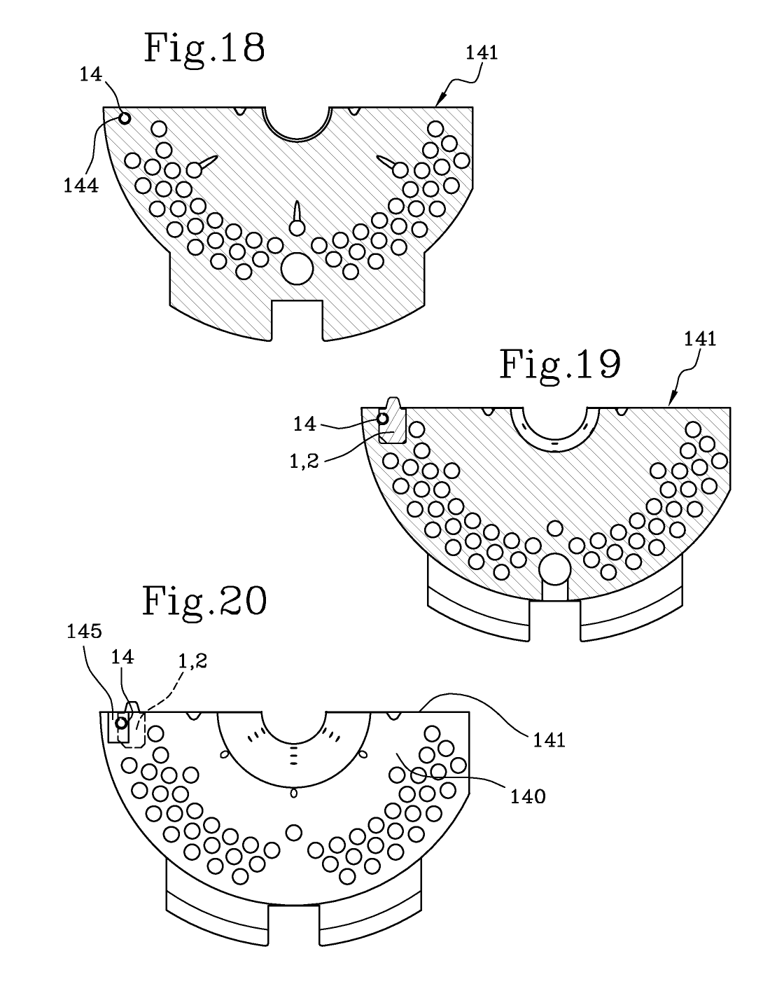

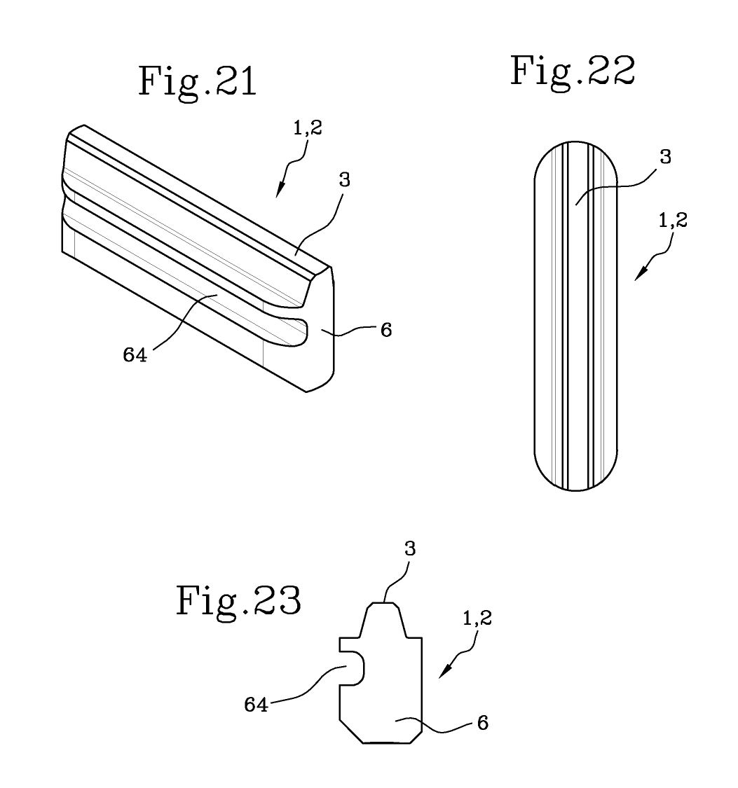

Also relative to the insertion and extraction of the inserts relative to the respective retaining grooves 5, there is a third embodiment (illustrated in FIGS. 15 to 23).

In the third example, each retaining groove 5 has, on the closing face 141 of the mould part, an opening 57, constituting an opening mouth through which the insert can be inserted and extracted. For this reason, the insert is inserted (that is, housed) and extracted with a movement perpendicular to the closing face 141 of the mould part.

The opening 57 of the retaining groove 5, formed on the closing face 141 of the mould part, is completely surrounded by the mould part to form a closed perimeter; thus, the retaining groove 5 is not completely open on the bottom wall 140, so it is not possible to insert the Insert by making it slide longitudinally along the retaining groove. This makes the mould particularly robust.

In the second and third embodiments, preferably, the anchoring portion 6 each of the inserts 1, 1′; 2, 2′ has a zone 61 of maximum width, that is to say, maximum extension in a direction transversal to a direction of moving towards each other of the inserts, proximal to a plane for closing the mould, that is proximal to the male or female element (projection 3 or recess 4).

Preferably, each of the inserts 1, 1′ comprises a single body in which the protrusion 3 is made in one piece with the anchoring portion 6 below it.

With regards to the first and the second embodiment, wherein the insert is removed by sliding longitudinally along the groove 5, use is made of an extractor tool.

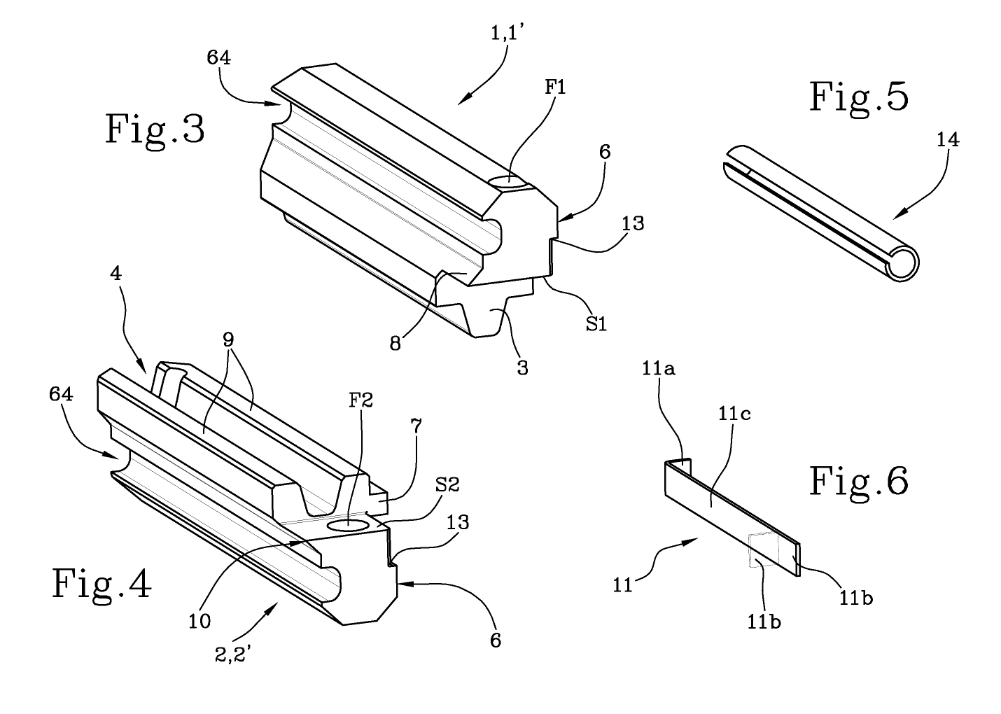

In this context, preferably, the operating portion of the insert (in particular the projection 3) has a longitudinal extension (along the closing line defined by the Insert 1, 1′) which is less than the longitudinal extension of the anchoring portion 6 in such a way that a portion 8 of the latter is protruding relative to the projection 3. The projecting portion 8 has a surface “S1”, directed on the side of the projection 3, on which a hole or cavity “F1” is made. The hole or cavity “F1” in the embodiment shown in FIG. 3 is a through hole. However, it might be blind and could be a dovetail-shaped groove, and hence accessible only from the side of the surface “S1” of the projecting portion 8.

Preferably, both the opposite ends of the insert have a corresponding surface S1 and a corresponding hole or cavity F1. This makes the inserts symmetrical and allows only one type of insert (if the operating portions are all equal) or at the most two types of insert (if the operating portions are of two different types: male and female), with consequent advantage in the storage and in the ease of assembly.

On the contrary, the surfaces S1 and recesses F1 are not necessary and, preferably, are not present, in the recess according to the third embodiment, wherein, preferably, the operating portion extends for the entire longitudinal length of the insert.

Each insert also comprises a lateral indentation, that is a recess 64 formed on the anchoring portion 6 and which extends preferably for the entire longitudinal extension of the anchoring portion 6.

The purpose of the hole or cavity “F1” and the lateral recess 64 is illustrated in more detail below.

Preferably, each of the second inserts 2, 2′ comprises a single body wherein the recess 4 is made from a longitudinal seat formed between two parallel protrusions 9 made in one piece with the anchoring portion 6 below it. Preferably, the recess 4 and the protrusions 9 have a longitudinal extension (along the closing line, defined by the insert 2, 2′) which is less than the longitudinal extension of the anchoring portion 6 in such a way that a portion 10 of the latter is projecting relative to the recess 4 and the protrusions 9. The projecting portion 10 has a surface “S2”, directed on the side of the recess 4, on which a hole or cavity “F2” is made. The hole or cavity “F2” in the embodiment illustrated in FIG. 4 is a through hole, however it may be blind and, therefore, accessible only from the side of the surface “S2” of the projecting portion 10.

If the recess F1, F2 is dovetail-shaped, it is possible to insert an end tooth of an extractor tool, without the risk of accidental disengagement of the tool from the insert.

Each insert 1, 1′, 2, 2′ is made in one piece from a material which has a hardness greater than that of the material used to make the mould parts 110, 111. Preferably, this insert 1, 1′ is made of a material having a hardness greater than 50 HRC, and even more preferably it is made of tool steel.

The mould 100 comprises locking means acting between each insert 1, 1′; 2, 2′ and the respective mould part 110, 111 for stably retaining the insert 1, 1′; 2, 2′ in a position in which it is locked relative to the mould part 110, 111, in particular in a locked position inside the retaining groove 5.

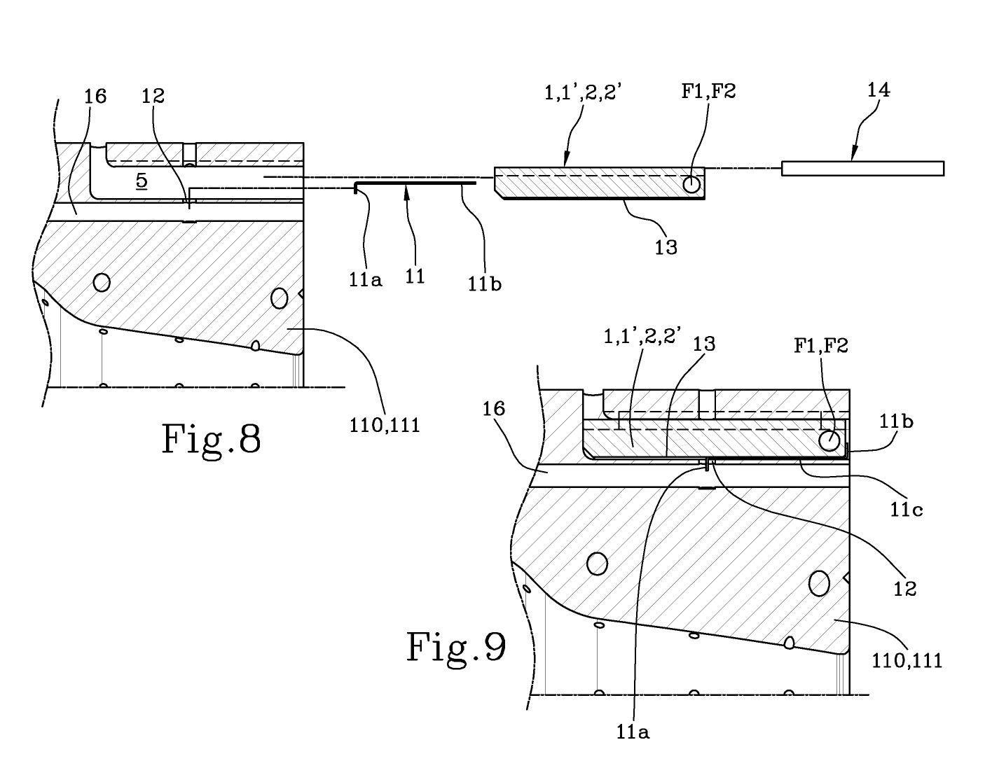

In one possible embodiment, the locking means comprise a plate 11 illustrated in detail in FIG. 6 and shown in FIGS. 2, 2A and 7 to 9. The plate 11 is deformable in a permanent manner and has a first end 11a constrained to a respective mould part 110, 111 and a second end 11b, opposite to the first end, which can be bent against an outer surface (front surface, that is to say, perpendicular to the direction of extension) of a respective insert 1, 1′; 2, 2′ for retaining the anchoring portion 6 in a position in which it is inserted in the retaining groove 5. The fixing of the first end 11a is obtained by inserting the first end 11a in a seat 12 made on a surface of the mould part 110, 111 defining the respective retaining groove 5 (FIGS. 8 and 9). The seat 12 is in particular made on a lateral portion of the retaining groove 5, perpendicularly to the bottom of the latter.

The plate 11, made preferably of metal material, is reversibly deformable to allow, as necessary, the extraction of the insert 1, 1′; 2, 2′ from the retaining groove 5, for example in the case of replacement of the insert.

The plate 11 also has a central portion 11c between the two ends 11a, 11b and interposed between the anchoring portion 6 and the respective retaining groove 5.

For this purpose, between the anchoring portion 6 and the respective retaining groove 5 there is a space which is substantially shaped to match the central portion 11c of the plate 11 to allow the housing of the central portion 11c of the plate 11. In the embodiment illustrated, the space is defined by a step 13 (FIGS. 3 and 4) made on a lateral surface of the anchoring portion 6 of each insert 1, 1′; 2, 2′ and preferably positioned adjacent to the above-mentioned lateral tooth 7.

According to an embodiment, the mould comprises a plate 11 which can be subject to permanent set deformation, having a first end 11a constrained to a respective mould part 110, 111 and a second end 11b, opposite to the first end, bendable against an outer surface of the anchoring portion 6 for retaining the anchoring portion 6 in a position in which it is inserted in the retaining groove 5. For each mould part, the plate 11 is active between each insert 1, 1′; 2, 2′ and the respective mould part 110, 111 for stably retaining the Insert 1, 1′; 2, 2′ in a position in which it is locked relative to the mould part 110, 111.

Preferably, the plate 11 comprises a central portion 11c between the two ends 11a, 11b and interposed between the anchoring portion 6 and the respective retaining groove 5, and wherein the first end 11a of the plate 11 is inserted in a seat 12 made in a surface of the mould part 110, 111 forming the respective retaining groove 5.

Preferably, (in addition to or as an alternative to the plate 11) the locking means comprise, for each insert 1, 1′; 2, 2′, an expandable elastic element 14 (elastic pin) interposed between the anchoring portion 6 and the respective retaining groove 5 for pressing the anchoring portion 6 against a contact surface 15 of the retaining groove 5.

Preferably, the contact surface 15, against which the anchoring portion 6 of the insert presses due to the elastic element 14, has a (first) face 15A perpendicular to a direction of moving towards each other of the inserts. Preferably, the contact surface 15 also has a second face 15B parallel to a direction of moving towards each other of the inserts.

Preferably, the elastic element 14 has an elongate shape; preferably, the elastic element 14 is annular or cylindrical. The expandable elastic element 14 is made preferably in the form of a curved plate. Preferably, the curved plate is wound to adopt a substantially cylindrical configuration having a longitudinal slot gap.

Alternatively, the elastic element 14 is a portion of the insert (for example a resilient curved plate), that is, the elastic element 14 is integral with the respective insert.

Preferably, the elastic element 14 is elastically deformable between a contracted position, wherein it defines a first transversal section (transversal to a longitudinal direction along which it extends), and an expanded position, wherein it defines a second transversal section greater than the first transversal section.

The expandable elastic element 14 is active at least on a part of the anchoring portion 6 opposite the contact surface 15 (therefore opposite the step 13) in such a way as to press the anchoring portion 6 against a contact surface 15. Preferably, the expandable elastic element 14 is configured to act along two different directions, for example perpendicular to each other, to apply a pressure between the insert 3 and the groove 4 along walls inclined to each other (for example, at approximately 90 degrees).

In more detail, the expandable elastic element 14 acts on (and is partly housed in) the respective lateral recess 64 of the anchoring portion 6, described above. The lateral recess 64 has a transversal profile preferably rounded in order to better adapt to the outer curved profile of the expandable elastic element 14 (FIGS. 3, 4).

Preferably, the contact surface 15 has at least one flat section and has a machining tolerance which is more stringent than that of the remaining part of the retaining groove 5. This machining tolerance is preferably grade ISO IT7.

Therefore, preferably, each retaining groove 5 has the hollow 54 (defining an undercut) configured to house the respective expandable elastic element 14. Preferably, the hollow 54 has a profile at least partly cylindrical.

Preferably, the hollow portion 54 of the retaining groove and the recess 64 of the cavity are shaped to form, when the cavity is housed in the retaining groove 5, a space shaped to contain the elastic element 14 in its contracted configuration. In that way, when the elastic element 14 is inserted in this space, between the retaining groove 5 and the anchoring portion 6 of the insert, it presses the insert against the surfaces of the groove 5 opposite to that where the hollow 54 is made, ensuring a stable and robust connection of the cavity in the groove.

Preferably, the space (for housing the elastic element 14 between the groove 5 and the recess) is substantially cylindrical. Preferably, this space is longitudinally elongate. With regards to an introduction of the expandable elastic element 14 between the retaining groove 5 and the insert housed therein and a removal of an expandable elastic element 14, it is performed preferably by moving the elastic element 14 along the longitudinal direction.

In the case of the first and second embodiment, the elastic element 14 is introduced and removed together with the insert, along the retaining groove 5, through the opening of the retaining groove 140 on the bottom wall 5 of the mould part.

In the third embodiment, the elastic element 14 is introduced and removed separately from the insert, through a passage 144 (preferably a cylindrical hole) made in the mould part and open on the retaining groove 5 and on an outer surface of the mould part, in particular on the bottom wall 140 of the mould part.

More specifically, the insert is firstly housed in the groove 5, then the elastic element 14 is inserted (pushed) through a passage 144 to the operating position between the insert and the groove (in the space formed by the hollow 54 and the recess 64).

More specifically, to facilitate a removal of the elastic element 14, each mould part has at least one extraction recess 145, made on the closing face 141 and communicating with the passage 144. The retaining groove 5 is interposed, along an axis the passage 144, between the extraction recess 145 and an opening of the passage 144 on the outside surface of the mould part.

Preferably, the passage 144 is oriented along a second longitudinal axis parallel to a first longitudinal axis (along which the groove 5 is oriented).

In order to extract the elastic element, it is pushed through the passage 144, until it reaches the extraction recess 145, through which the mould part is removed.

FIG. 8 shows a sequence of applying an insert 1, 1′; 2, 2′ to a mould part 110, 111 (this figure applies for any of the four inserts and for any of the two mould parts).

According to one optional aspect of the invention, in accordance with this sequence, the plate 11, having initially the second end 11b coplanar with the central portion 11c, is initially inserted in the retaining groove 5 until the first end 11a is inserted in the seat 12. In this configuration, the plate 11 lies against a lateral side panel of the retaining groove 5 (FIGS. 8 and 9 show respective cross sections through a plane parallel to the interface between the two mould parts).

To promote a subsequent extraction of the plate 11, it is possible to provide a duct 16 which runs parallel to the retaining groove 5 and in which the through seat 12 leads. In this configuration, once the plate 11 is inserted in a position, the first end 11a of the latter s projecting inside the duct 16 (FIG. 9) and can be pressed towards the retaining groove 5 to prevent removal of the plate 11.

After the positioning the plate 11, the insert 1, 1′; 2, 2′ and the expandable elastic element 14 are inserted. Lastly, the second end 11b of the plate 11 is folded against a front wall of the insert 1, 1′; 2, 2′, in particular of the anchoring portion 6, locking the insert 1, 1′; 2, 2′ in position inside the retaining groove 5 (FIG. 9).

The insert 1, 1′; 2, 2′ is mounted in such a way that the hole or cavity “F1”, “F2” is positioned outermost, towards the access area of the retaining groove 5. In that way, the hole or cavity “F1, “F2” is able to engage with a corresponding gripping portion of an extractor tool (not illustrated) designed to extract the insert 1, 1′; 2, 2′ the from the retaining groove 5.

Preferably, the two inserts 1, 1′; 2, 2′ of each pair of inserts are facing each other, also the respective holes “F1”, “F2” are facing each other in the closed configuration of the mould 100; in this configuration it is possible to grip both the inserts 1, 1′; 2, 2′ simultaneously by means of a single extracting tool having two gripping portions.

It should be noted that the mould may be made in various ways, also different from that illustrated by way of an example in the drawings. For example, the mould may be made using two mould parts not hinged to each other but otherwise movable, for example slidable towards each other. Moreover, the mould may comprise a base or be without a base and can have a number of mould parts different from two.

Moreover, the inserts may be applied in a “cross” configuration, that is to say, in such a way that each mould part has both inserts of the “male” type and inserts of the “female” type.

In a variant embodiment, there might be present only inserts of the “male” type, whilst the inserts of a “female” type would be replaced by “traditional” type recesses made of the material constituting the respective mould part, or vice versa.

It should be noted that this description also provides a mould for forming objects, comprising a pair of mould parts 110, 111, stably couplable to each other (for example, using a hinge) during an operating cycle of the mould 100 and between them defining a space 120 for forming an object to be produced.

Each mould part has a corresponding retaining groove 5, designed (that is, configured) to receive by sliding a corresponding insert of a pair of inserts 1, 1′; 2, 2′, to allow a mutual engagement of the inserts in a closed configuration of the mould 100 and thereby determine a mutual positioning of the mould parts 110, 111 according to a predetermined arrangement in the closed configuration of the mould 100.

Preferably, each mould part has a portion 51, delimiting one side of the corresponding retaining groove 5, which is elastically deformable to enlarge and narrow the groove 5 in a direction transversal to a direction of moving towards each other of the inserts.

Preferably, the portion 51 of the elastically deformable mould part is interposed between the retaining groove 5 and an outer periphery of the mould part and constitutes a wing encircling one side of the retaining groove.

Preferably, each retaining groove 5 has a hollow 54 (forming an undercut) configured to accommodate the expandable elastic element 14 (designed to be operatively interposed between the insert and the respective retaining groove 5 for pressing the insert against a contact surface 15 of the retaining groove 5).

Preferably, each contact surface 15 has a first face 15A perpendicular to a direction of moving towards each other of the inserts; the first face 15A is preferably flat; moreover, the first face 15A is preferably parallel to the face 141 for closing the mould part (that is, the plane closing the mould, when the mould is in the dosed configuration).

Preferably, each contact surface 15 has a second face 15B parallel to a direction of moving towards each other of the inserts; the second face 15B is preferably flat; moreover, the second face 15B is preferably perpendicular to the face 141 for closing the mould part (that is, the plane closing the mould, when the mould is in the dosed configuration).

Preferably, the lateral hollow 54 extends for the entire longitudinal extension of the retaining groove 5.

This description also provides a method for making a mould for forming objects. The method is also applicable to moulds made with other technologies (for example with non-removable inserts) for adapting it to receive the removable inserts which can be locked with elastic means according to this invention.

This method comprises a step of preparing a pair of mould parts 110, 111 stably couplable to each other during an operating cycle of the mould 100 and between them defining a space 120 for forming an object to be produced.

The method also comprises a step for making for each mould part, for removal of material from the mould part (for example by cutting), a corresponding retaining groove 5, configured to receive by sliding a corresponding insert of a pair of inserts 1, 1′; 2, 2′, so as to allow mutual engagement of the inserts in a dosed configuration of the mould 100 and thereby determine a mutual positioning of the mould parts 110, 111 according to a predetermined arrangement in the closed configuration of the mould 100.

Moreover, the method comprises a step for making, for each mould part, for removal of material from the mould part (for example, by drilling the bottom wall 140 of the mould part or by cutting with a spherical cutter), a hollow 54 in the retaining groove 5, wherein the hollow 54 forms an undercut configured to accommodate one expandable elastic element 14, designed to be operatively interposed between the insert and the respective retaining groove 5 for pressing the insert against a contact surface 15 of the retaining groove 5.

More specifically (in the third embodiment), the method comprises making, for removal of material from each mould part (for example drilling from the bottom wall 140 of the mould part), a passage 144 (preferably a hole) made inside the mould part and open on the retaining groove 5 and on an outer surface of the mould part.

Preferably, the passage 144 is made before the groove 5.

Preferably, the method also comprises making an extraction recess 145, formed on the closing face 141 and which communicates with the passage 144.

The retaining groove 5 is interposed, along an axis the passage 144, between the extraction recess 145 and an opening of the passage 144 on the outside surface of the mould part.

Preferably, the extraction groove 145 is made after the passage 144.

This invention also provides an insert for moulds for forming objects, removably couplable to a mould part of a pair of mould parts of the mould so as to constitute a contact element, acting between the mould parts to determine mutual positioning of the mould parts 110, 111 according to a predetermined arrangement in a closed configuration of the mould 100.

The insert 1, 1′, 2, 2′ comprises a process portion intended to be coupled to a corresponding process portion of the other mould part of the pair of mould parts, and an anchoring portion 6 which is elongate along a longitudinal direction of extension of the insert and facing in the opposite direction to the contact portion, relative to a direction transversal to the direction of extension.

The anchoring portion 6 on at least one side wall has a recess 64 longitudinally elongate and configured to house a part of a expandable elastic element 14, operatively interposed between the anchoring portion 6 and the respective mould part.

Preferably, the anchoring portion 6 is free of protuberances and lateral protrusions.

Preferably, the anchoring portion 6 and the operating portion are opposite to each other relative to an operating direction, wherein the anchoring portion 6 has a plurality of edges oriented along the operating direction, wherein the edges are rounded or chamfered.

Preferably, the insert is elongate in a longitudinal direction. The anchoring portion 6 has, on one or both the opposite ends relative to the longitudinal direction, a flat contact wall, perpendicular to the longitudinal direction. This to prevent, during insertion of the elastic element 14, the insert damaging the mould part or itself by pressing against it.

The invention achieves the set aim by overcoming the disadvantages of the prior art.

The use of closing couplings in the form of removable and replaceable inserts makes it possible to always guarantee an optimum and geometrically correct closing, reducing the costs and the time for maintenance and repairs and increasing the service life of the mould. The inserts may also be made of materials different from the material of the mould parts and more suitable for the purpose, as well as treated with hardening processes which prevent wear, in view especially of the severe operating conditions to which the closing couplings are subjected.

1. A mould for forming objects, comprising:
a pair of mould parts or half-moulds, stably couplable to each other during an operating cycle of the mould and between them defining a space for forming an object to be produced;
at least one pair of inserts, mutually engageable in a closed configuration of the mould to determine, by contact between said inserts, mutual positioning of the mould parts according to a predetermined arrangement in the closed configuration of the mould, wherein each insert has a respective anchoring portion which can be inserted in a retaining groove made in a respective mould part and is removably connected to the respective mould part;
an expandable elastic element, operatively interposed between the anchoring portion of each insert and the respective retaining groove, for pressing the anchoring portion against a contact surface of the retaining groove.

2. The mould according to claim 1, wherein, for each of said inserts, the anchoring portion is able to slide in the corresponding retaining groove of the respective mould part, for connecting the insert to the respective mould part.

3. The mould according to claim 1, wherein each mould part has a closing face which, in the closed configuration of the mould, is positioned in contact with a corresponding face for closing the other mould part, in a closing plane of the mould, and wherein each retaining groove has, on said closing face, an opening completely surrounded by the mould part to form a closed perimeter, the corresponding insert being insertable in and extractable from the respective retaining groove through said opening.

4. The mould according to claim 3, wherein each mould part, in addition to the retaining groove, has a passage made in the mould part and open on the retaining groove and on an outer surface of the mould part, so as to allow an insertion of the elastic element through the passage and a positioning of the elastic element between the insert housed in the retaining groove and the retaining groove.

5. The mould according to claim 4, wherein each mould part has at least an extraction recess, made on the closing face and which communicates with said passage, wherein the retaining groove is interposed, along an axis the passage, between the extraction recess and an opening of the passage on the outside surface of the mould part.

6. The mould according to claim 4, wherein each retaining groove is elongate along a first longitudinal axis and said passage is oriented along a second longitudinal axis parallel to the first longitudinal axis and is open on the outside surface of the mould part defined by a bottom wall of the mould part perpendicular to a plane closing the mould.

7. The mould according to claim 1, wherein the inserts of said at least one pair of inserts have an elongate shape along a longitudinal line and are slidably insertable in the respective retaining grooves along said longitudinal direction, wherein the retaining grooves are open on a bottom wall of the mould part, perpendicular to a plane closing the mould, wherein each insert is operatively housed in the respective retaining groove by interference and wherein a portion of the mould part delimiting a side of the retaining groove is elastically deformable for enlarging and narrowing the retaining groove in a direction transversal to a direction of moving towards each other of the inserts.

8. (canceled)

9. The mould according to claim 1, wherein said anchoring portion defines a recess configured for housing the expandable elastic element, operatively interposed between the anchoring portion and the respective retaining groove, for pressing the anchoring portion against a contact surface of said retaining groove.

10. (canceled)

11. The mould according to claim 1, wherein each insert is elongate along a longitudinal direction and, on at least one lateral wall, has a recess longitudinally elongate and configured to house the expandable elastic element, operatively interposed between the anchoring portion and the respective retaining groove.

12. (canceled)

13. The mould according to claim 1, wherein the anchoring portion of each of said inserts has a zone of maximum width, in a direction transversal to a direction of moving towards each other of the inserts, near an operating portion of the recess, designed to abut the operating portion of a corresponding insert of the pair of inserts.

14. An insert for moulds for forming objects, removably couplable to a mould part of a pair of mould parts of the mould so as to constitute a contact element, acting between said mould parts to determine mutual positioning of the mould parts according to a predetermined arrangement in a closed configuration of the mould, comprising an operating portion designed to be coupled to a corresponding operating portion of the other mould part of the pair of mould parts, and an anchoring portion which is elongate along a longitudinal direction of extension of the insert and which faces opposite the contact portion, relative to a direction transversal to said longitudinal direction, wherein the anchoring portion has on at least one side wall a recess longitudinally elongate and configured to house a part of a expandable elastic element, operatively interposed between the anchoring portion and the respective mould part.

15. (canceled)

16. The insert according to claim 14, wherein the anchoring portion and the operating portion are opposite to each other relative to an operating direction, wherein the anchoring portion has a plurality of edges oriented along the operating direction, wherein the edges are rounded or chamfered.

17. (canceled)

18. A method for carrying out maintenance on a mould for forming objects, for at least one mould part of a pair of mould parts of the mould, comprising the following steps:
extracting, from a retaining groove made in the mould part, first insert which constitutes a contact element, acting between said mould parts to determine mutual positioning of the mould parts according to a predetermined arrangement in a closed configuration of the mould;
inserting in said groove second insert which constitutes a contact element, acting between said mould parts to determine mutual positioning of the mould parts according to a predetermined arrangement in a closed configuration of the mould, wherein said second insert substitutes the first insert that was previously extracted,
removing an expandable elastic element, operatively interposed between the insert and the respective retaining groove;
introducing the expandable elastic element between the retaining groove and the insert housed therein in said inserting step.

19. The method according to claim 18, wherein the step of removing the expandable elastic element precedes the step of extracting the insert from the retaining groove, and wherein the step of introducing the expandable elastic element follows the step of inserting the insert in said retaining groove.

20. The method according to claim 19, wherein each mould part of the mould has a face for closing the mould part which, in the closed configuration of the mould, is positioned in contact with a corresponding face for closing the other mould part, in a closing plane of the mould, wherein the steps of inserting and extracting the insert in and from the retaining groove occur perpendicularly to the closing face, and wherein the removal and introduction of the expandable elastic element occur through a passage oriented parallel to the closing face.

21. A mould for forming objects, comprising a pair of mould parts, stably couplable to each other during an operating cycle of the mould and between them defining a space for forming an object to be produced, wherein each mould part has a corresponding retaining groove configured to receive by sliding a corresponding insert of a pair of inserts, so as to allow mutual engagement of the inserts in a closed configuration of the mould and thereby determine a mutual positioning of the mould parts according to a predetermined arrangement in the closed configuration of the mould, wherein each retaining groove has a hollow forming an undercut configured to accommodate one expandable elastic element, designed to be operatively interposed between the insert and the respective retaining groove for pressing the insert against a contact surface of the retaining groove.

22. The mould according to claim 21, wherein each mould part of the mould has a face for closing the mould part which, in the closed configuration of the mould, is positioned in contact with a corresponding face for closing the other mould part, in a closing plane of the mould, and wherein each contact surface has a first face parallel to the closing face and a second face perpendicular to the closing face.

23. The mould according to claim 21, wherein each mould part, in addition to the retaining groove, has a passage made in the mould part and open on the retaining groove and on an outer surface of the mould part, so as to allow an insertion of the elastic element through the passage and a positioning of the elastic element between the insert housed in the retaining groove and the retaining groove.

24. The mould according to claim 21, wherein each mould part has a closing face which, in the closed configuration of the mould, is positioned in contact with a corresponding face for closing the other mould part, in a closing plane of the mould, and wherein each retaining groove has, on said closing face, an opening completely surrounded by the mould part to form a closed perimeter, and it is configured to allow an insertion and an extraction of an insert from the respective retaining groove through said opening.

25. The mould according to claim 21, wherein each mould part has a portion, delimiting one side of the corresponding retaining groove, which is elastically deformable for enlarging and narrowing the recess in a direction transversal to a direction of moving towards each other of the inserts, interposed between the retaining groove and a outer periphery of the mould part and constitutes a wing encircling one side of the retaining groove.

26-27. (canceled)
